(19) United States
(12) Patent Application Publication
(10) Pub. No.: US 2014/0378269 A1
(43) Pub. Date: Dec. 25, 2014

(54) TEN-SPEED TRANSMISSION WITH START AND STOP ENABLER

(71) Applicant: GM Global Technology Operations LLC, Detroit, MI (US)

(72) Inventors: Casie M. Bockenstette, Clarkston, MI (US); Carlos E. Marin, Oxford, MI (US); Paul G. Otanez, Troy, MI (US); Craig S. Ross, Ypsilanti, MI (US)

(21) Appl. No.: 13/921,912

(22) Filed: Jun. 19, 2013

(51) Int. Cl. F16H 3/62

(52) U.S. Cl. CPC F16H 3/62
USPC 475/276; 475/275

(57) ABSTRACT

A transmission is provided having an input member, an output member, four planetary gear sets, a plurality of coupling members and a plurality of torque transmitting devices. Each of the planetary gear sets includes first, second and third members. The torque transmitting devices include clutches and brakes. An transmission auto start/stop enabler includes one or multiple latches. The latches engage one or more of the plurality of torque transmitting devices during an engine auto stop/start event or in preparation for a stop of the motor vehicle.

### FIELD

The invention relates generally to a multiple speed transmission enabled for automatic engine start/stop and more particularly to a multiple speed transmission having a plurality of planetary gear sets and a plurality of torque transmitting devices and one or a plurality of latches for enabling automatic engine start/stop or reducing pump requirements.

### BACKGROUND

The statements in this section merely provide background information related to the present disclosure and may or may not constitute prior art.

A typical automatic transmission includes a hydraulic control system that, among other functions, is employed to actuate a plurality of torque transmitting devices and to provide lubrication and cooling to the components of the transmission. The conventional hydraulic control system typically includes a main pump that provides a pressurized fluid, such as automatic transmission oil, to a plurality of valves and solenoids within a valve body. The main pump is driven by the engine of the motor vehicle. The valves and solenoids are operable to direct the pressurized hydraulic fluid through a hydraulic fluid circuit to the components of the transmission. For example the pressurized hydraulic fluid delivered to the torque transmitting devices is used to engage or disengage the devices in order to obtain different gear ratios.

In order to increase the fuel economy of motor vehicles, it is desirable to stop the engine during certain circumstances, such as when stopped at a red light or idling. However, during this automatic stop, the pump is no longer driven by the engine. Accordingly, hydraulic fluid pressure within the hydraulic control system drops. This leads to clutches and/or brakes within the transmission to be fully disengaged. As the engine restarts, these clutches and/or brakes may take time to reengage fully, thereby producing slippage and delay between engagement of the accelerator pedal or release of the brake and the movement of the motor vehicle. Therefore, there is a need in the art for an automatic transmission enabled for engine stop-start events such that the automatic start/stop event does not affect transmission operating performance.

### SUMMARY

A transmission in a motor vehicle is provided. The transmission includes an input member, an output member, first, second, third and fourth planetary gear sets each having first, second and third members, six torque transmitting mechanisms selectively engageable to interconnect one of the first, second, and third members with at least one other of the first members, second members, third members and a stationary member, wherein the torque transmitting mechanisms are selectively engageable in combinations of at least four to establish at least ten forward speed ratios and at least one reverse speed ratio between the input member and the output member, and a first latching mechanism connected to a fifth of the six torque transmitting mechanisms, wherein the first latching mechanism latches the fifth torque transmitting mechanism in a ready state when the motor vehicle is stopped, and a second latching mechanism connected to a sixth of the six torque transmitting mechanisms, wherein the second latching mechanism latches the sixth torque transmitting mechanism in a ready state. The ready state refers to various states or conditions of the clutch may include a filled state where oil is fed to the circuits that actuate the clutch, a staged state where the clutch has been moved to near full engagement, and an engaged state where the clutch is fully engaged and ready to transmit torque, or any other state in between. The fifth and sixth torque transmitting mechanisms are in the ready state during a first forward gear. In another example, a third latching mechanism is connected to a first of the six torque transmitting mechanisms, wherein the third latching mechanism latches the first torque transmitting mechanism in a ready state. The fifth, sixth, and first torque transmitting mechanisms are in the ready state during a first forward gear and a second forward gear.

In one example of the present invention the fifth and sixth torque transmitting mechanisms are in the ready state during a reverse gear. In another example of the present invention the fifth, sixth, and first torque transmitting mechanisms are in the ready state during a reverse gear.

In another example of the present invention the first latching mechanism latches the fifth torque transmitting device during a startup of the motor vehicle after an automatic engine stop event and the second latching mechanism latches the sixth torque transmitting device during the startup of the motor vehicle after the automatic engine stop event. In another example of the present invention, the first latching mechanism latches the fifth torque transmitting device during a startup of the motor vehicle after an automatic engine stop event and the second latching mechanism latches the sixth torque transmitting device during the startup of the motor vehicle after the automatic engine stop event and a third latching mechanism latches the first torque transmitting device during the startup of the motor vehicle after the automatic stop event.

In yet another example of the present invention the first and second latching mechanisms are hydraulic latching mechanisms. In yet another example of the present invention the first, second, and third latching mechanisms are hydraulic latching mechanisms.

In yet another example of the present invention the first, second, and third latching mechanisms are mechanical latching mechanisms that are mechanically coupled to the fifth and sixth torque transmitting mechanisms.

In yet another example of the present invention a first interconnecting member continuously interconnects the third member of the first planetary gear set with the first member of the second planetary gear set. A second interconnecting member continuously interconnects the second member of the second planetary gear set with the third member of the third planetary gear set. A third interconnecting member continuously interconnects the first member of the third planetary gear set with the third member of the fourth planetary gear set.

In another embodiment of the present invention, a first of the six torque transmitting mechanisms is selectively engageable to interconnect the first member of the first planetary gear set with the first member of the fourth planetary gear set.

In yet another embodiment of the present invention, a second of the six torque transmitting mechanisms is selectively engageable to interconnect the first member of the first planetary gear set with the second member of the fourth planetary gear set.

In yet another embodiment of the present invention, a third of the six torque transmitting mechanisms is selectively engageable to interconnect the input member with at least one of the first member of the third planetary gear set and the third member of the fourth planetary gear set.

In yet another embodiment of the present invention, a fourth of the six torque transmitting mechanisms is selectively engageable to interconnect at least one of the second member of the second planetary gear set and the third member of the third planetary gear set with the second member of the fourth planetary gear set.

In yet another embodiment of the present invention, a fifth of the six torque transmitting mechanisms is selectively engageable to interconnect at least one of the third member of the first planetary gear set and the first member of the second planetary gear set with the stationary member.

In yet another embodiment of the present invention, a sixth of the six torque transmitting mechanisms is selectively engageable to interconnect the third member of the second planetary gear set with the stationary member.

In yet another embodiment of the present invention, the third member of the first planetary gear set and first member of the second, third and fourth planetary gear sets are sun gears, the second members of the first, second, third and fourth planetary gear sets are carrier members and the first member of the first planetary gear set and third member of the second, third and fourth planetary gear sets are ring gears.

In still another embodiment of the present invention, the input member is continuously interconnected with the second member of the first planetary gear set and the output member is continuously interconnected with the second member of the third planetary gear set.

In still another embodiment of the present invention, two of the torque transmitting mechanisms are brakes and four of the torque transmitting mechanisms are clutches.

In still another embodiment of the present invention, the stationary member is a transmission housing.

Further features, aspects and advantages of the present invention will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a lever diagram of an embodiment of a ten speed transmission according to the present invention;

FIG. 2 is a diagrammatic illustration of an embodiment of a ten speed transmission according to the present invention;

FIG. 3 is a truth table presenting the state of engagement of the various torque transmitting elements in each of the available forward and reverse speeds or gear ratios of the transmission illustrated in FIGS. 1 and 2; and

FIG. 4 is a block diagram of the transmission shown with an engine start/stop enabler.

### DETAILED DESCRIPTION

The following description is merely exemplary in nature and is not intended to limit the present disclosure, application, or uses.

At the outset, it should be appreciated that the embodiments of the ten speed automatic transmission having an auto stop/start enabler of the present invention have an arrangement of permanent mechanical connections between the elements of the four planetary gear sets. For example, a third component or element of a first planetary gear set is permanently coupled to a first component or element of the second planetary gear set. A second component or element of a second planetary gear set is permanently coupled to a third component or element of the third planetary gear set. A first component or element of the third planetary gear set is permanently coupled to third component or element of the fourth planetary gear set.

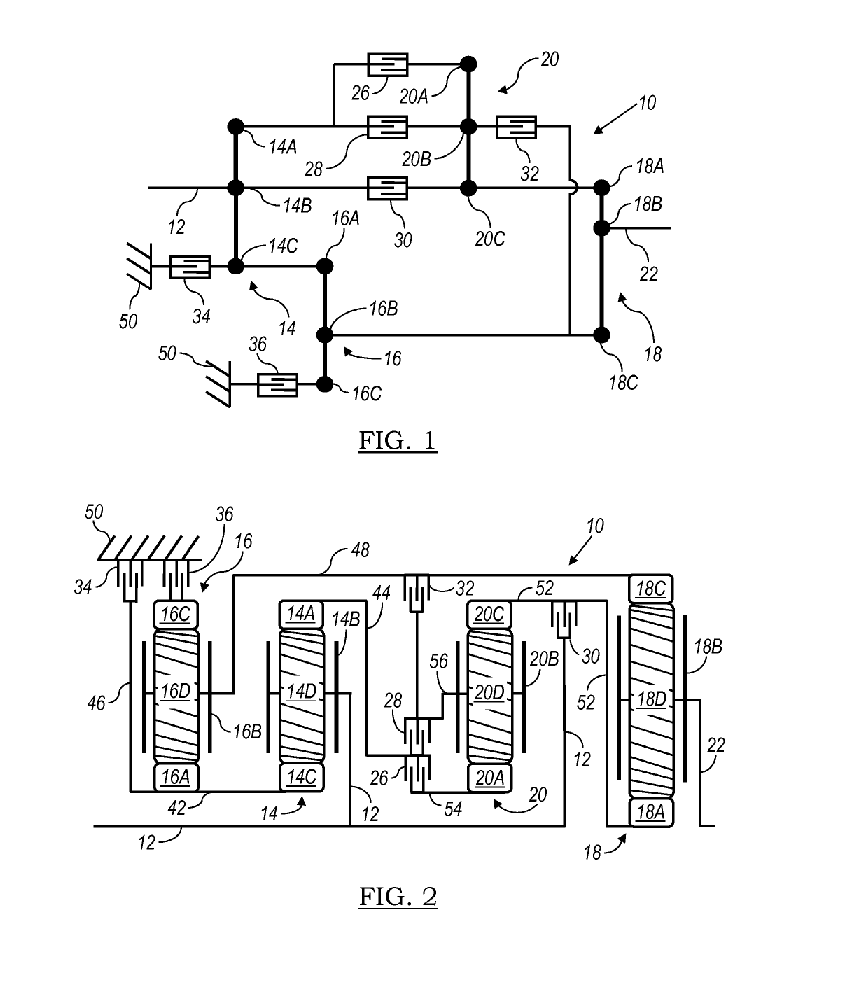

Referring now to FIG. 1, an embodiment of a ten speed transmission 10 is illustrated in a lever diagram format. A lever diagram is a schematic representation of the components of a mechanical device such as an automatic transmission. Each individual lever represents a planetary gear set wherein the three basic mechanical components of the planetary gear are each represented by a node. Therefore, a single lever contains three nodes: one for the sun gear, one for the planet gear carrier, and one for the ring gear. The relative length between the nodes of each lever can be used to represent the ring-to-sun ratio of each respective gear set. These lever ratios, in turn, are used to vary the gear ratios of the transmission in order to achieve an appropriate ratios and ratio progression. Mechanical couplings or interconnections between the nodes of the various planetary gear sets are illustrated by thin, horizontal lines and torque transmitting devices such as clutches and brakes are presented as interleaved fingers. Further explanation of the format, purpose and use of lever diagrams can be found in SAE Paper 810102, “The Lever Analogy: A New Tool in Transmission Analysis” by Benford and Leising which is hereby fully incorporated by reference.

The transmission 10 includes an input shaft or member 12, a first planetary gear set 14 having three nodes: a first node 14A, a second node 14B and a third node 14C, a second planetary gear set 16 having three nodes: a first node 16A, a second node 16B and a third node 16C, a third planetary gear set 18 having three nodes: a first node 18A, a second node 18B and a third node 18C, a fourth planetary gear set 20 having three nodes: a first node 20A, a second node 20B and a third node 20C and an output shaft or member 22.

The input member 12 is coupled to the second node 14B of the first planetary gear set 14. The output member 22 is coupled to the second node 18B of the third planetary gear set 18. The third node 14C of the first planetary gear set 14 is coupled to the first node 16A of the second planetary gear set 16. The second node 16B of the second planetary gear set 16 is coupled to the third node 18C of the third planetary gear set 18. The first node 18A of the third planetary gear set 18 is coupled to the third node 20C of the fourth planetary gear set 20.

A first clutch 26 selectively connects the first node 14A of the first planetary gear set 14 with the first node 20A of the fourth planetary gear set 20. A second clutch 28 selectively connects the first node 14A of the first planetary gear set 14 with the second node 20B of the fourth planetary gear set 20. A third clutch 30 selectively connects the second node 14B of the second planetary gear set 14 to the third node 20C of the fourth planetary gear set 20. A fourth clutch 32 selectively connects the second node 16B of the second planetary gear set 16 and the third node 18C of the third planetary gear set 18 with the second node 20B of the fourth planetary gear set 20. A first brake 34 selectively connects the third node 14C of the first planetary gear set 14 to a stationary member or transmission housing 50. A second brake 36 selectively connects the third node 16C of the second planetary gear set 16 to a stationary member or transmission housing 50.

Referring now to FIG. 2, a stick diagram presents a schematic layout of the embodiment of the ten speed transmission 10 according to the present invention. In FIG. 2, the numbering from the lever diagram of FIG. 1 is carried over. The clutches and couplings are correspondingly presented whereas the nodes of the planetary gear sets now appear as components of planetary gear sets such as sun gears, ring gears, planet gears and planet gear carriers.

For example, the planetary gear set 14 includes a sun gear member 14C, a ring gear member 14A and a planet gear carrier member 14B that rotatably supports a set of planet gears 14D (only one of which is shown). The sun gear member 14C is connected for common rotation with a first shaft or intermediate member 42. The ring gear member 14A is connected for common rotation with a second shaft or intermediate member 44. The planet carrier member 14B is connected for common rotation with input shaft or member 12. The set of planet gears 14D are each configured to intermesh with both the sun gear member 14C and the ring gear member 14A.

The planetary gear set 16 includes a sun gear member 16A, a ring gear member 16C and a planet gear carrier member 16B that rotatably supports a set of planet gears 16D (only one of which is shown). The sun gear member 16A is connected for common rotation with first shaft or intermediate member 42 and with a third shaft or intermediate member 46. The ring gear member 16C is connected to brake 36. The planet carrier member 16B is connected for common rotation with a fourth shaft or intermediate member 48. The planet gears 16D are each configured to intermesh with both the sun gear member 16A and the ring gear member 16C.

The planetary gear set 18 includes a sun gear member 18A, a ring gear member 18C and a planet gear carrier member 18B that rotatably supports a set of planet gears 18D (only one of which is shown). The sun gear member 18A is connected for common rotation with a fifth intermediate member 52. The ring gear member 18C is connected for common rotation with a fourth shaft or intermediate member 48. The planet carrier member 18B is connected for common rotation with the output shaft or member 22. The planet gears 18D are each configured to intermesh with both the sun gear member 18A and the ring gear member 18C.

The planetary gear set 20 includes a sun gear member 20A, a ring gear member 20C and a planet gear carrier member 20B that rotatably supports a set of planet gears 20D (only one of which is shown). The planet gears 20D are each configured to intermesh with both the sun gear member 20A and the ring gear member 20C. The sun gear member 20A is connected for common rotation with a sixth shaft or intermediate member 54. The ring gear member 20C is connected for common rotation with fifth shaft or intermediate member 52. The planet carrier member 20B is connected for common rotation with a seventh intermediate member 56.

The input shaft or member 12 is continuously connected to an engine (not shown) or to a turbine of a torque converter (not shown). The output shaft or member 22 is continuously connected with the final drive unit or transfer case (not shown).

The torque-transmitting mechanisms or clutches 26, 28, 30, 32 and brakes 34 and 36 allow for selective interconnection of the shafts or interconnecting members, members of the planetary gear sets and the housing. For example, the first clutch 26 is selectively engageable to connect the second shaft or intermediate member 44 with the sixth shaft or intermediate member 54. The second clutch 28 is selectively engageable to connect the second shaft or intermediate member 44 with the seventh shaft or intermediate member 56. The third clutch 30 is selectively engageable to connect the input shaft or member 12 with the fifth shaft or intermediate member 52. The fourth clutch 32 is selectively engageable to connect the fourth shaft or intermediate member 48 with the seventh shaft or intermediate member 56. The first brake 34 is selectively engageable to connect the third shaft or intermediate member 46 with the stationary element or the transmission housing 50 in order to restrict the member 46 from rotating relative to the transmission housing 50. The second brake 36 is selectively engageable to connect the ring gear member 16C with the stationary element or the transmission housing 50 in order to restrict the member 16C from rotating relative to the transmission housing 50.

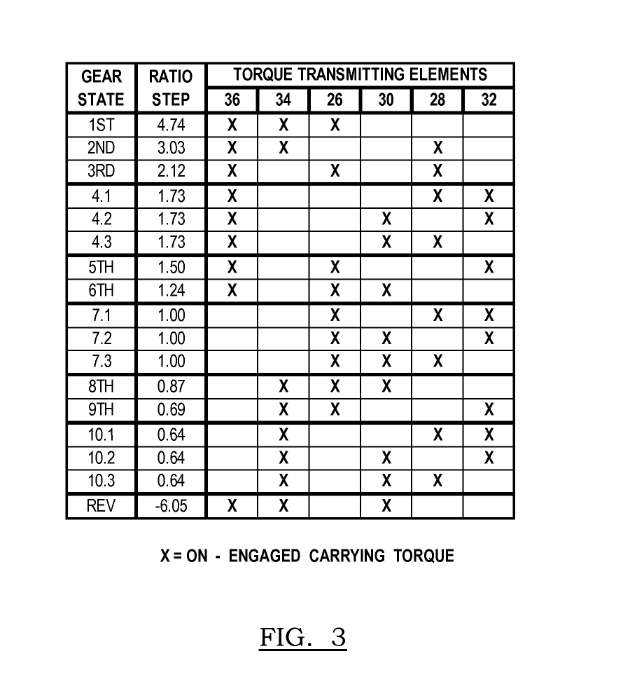

Referring now to FIG. 2 and FIG. 3, the operation of the embodiment of the ten speed transmission 10 will be described. It will be appreciated that transmission 10 is capable of transmitting torque from the input shaft or member 12 to the output shaft or member 22 in at least ten forward speed or torque ratios and at least one reverse speed or torque ratio with triple overdrive. Each forward and reverse speed or torque ratio is attained by engagement of one or more of the torque-transmitting mechanisms (i.e. first clutch 26, second clutch 28, third clutch 30, fourth clutch 32, first brake 34 and second brake 36), as will be explained below. FIG. 3 is a truth table presenting the various combinations of torque-transmitting mechanisms that are activated or engaged to achieve the various gear states. An “X” in the box means that the particular clutch or brake is engaged to achieve the desired gear state. Actual numerical gear ratios of the various gear states are also presented although it should be appreciated that these numerical values are exemplary only and that they may be adjusted over significant ranges to accommodate various applications and operational criteria of the transmission 10. An example of the gear ratios that may be obtained using the embodiments of the present invention are also shown in FIG. 3. Of course, other gear ratios are achievable depending on the gear diameter, gear teeth count and gear configuration selected.

To establish a reverse gear, the first clutch 26, fourth clutch 32, first brake 34 and second brake 36 are engaged or activated. The first clutch 26 connects the second shaft or intermediate member 44 with the sixth shaft or intermediate member 54. The fourth clutch 32 connects the fourth shaft or intermediate member 48 with the seventh shaft or intermediate member 56. The first brake 34 connects the third shaft or intermediate member 46 with the stationary element or the transmission housing 50 in order to restrict the member 46 from rotating relative to the transmission housing 50. The second brake 36 connects the ring gear member 16C with the stationary element or the transmission housing 50 in order to restrict the member 16C from rotating relative to the transmission housing 50. Likewise, the ten forward ratios are achieved through different combinations of clutch and brake engagement, as shown in FIG. 3.

It will be appreciated that the foregoing explanation of operation and gear states of the ten speed transmission 10 assumes, first of all, that all the clutches not specifically referenced in a given gear state are inactive or disengaged and, second of all, that during gear shifts, i.e., changes of gear state, between at least adjacent gear states, a clutch engaged or activated in both gear states will remain engaged or activated.

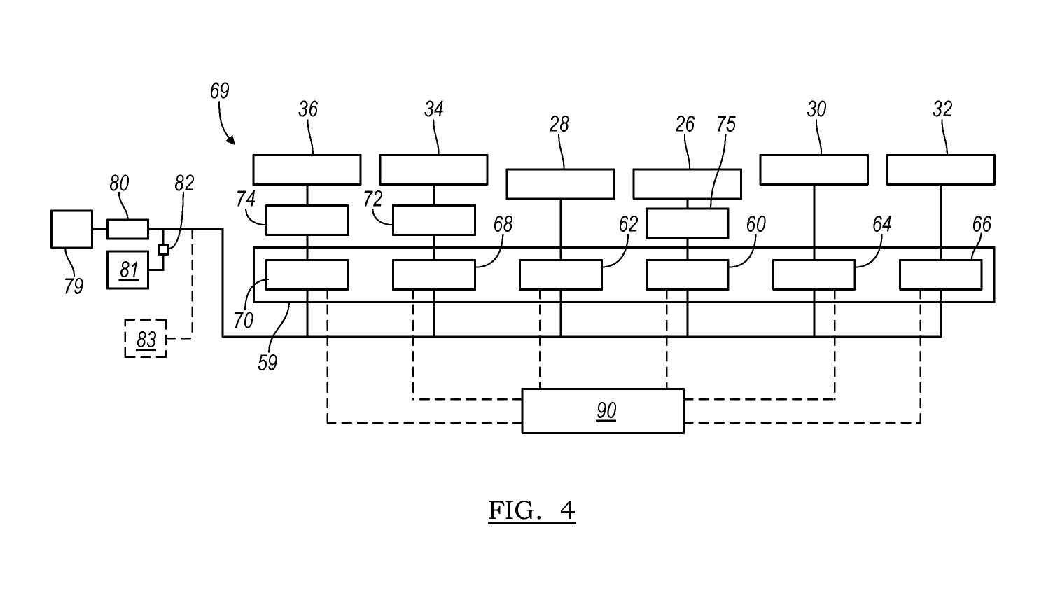

Turning to FIG. 4, the transmission 10 includes an engine start/stop enabler system 69 that includes a locking or latching mechanism 72 associated with the first brake 34 and a locking or latching mechanism 74 associated with the second brake 36. In an alternate embodiment, a third locking or latching mechanism 75 is associated with the first clutch 26. The transmission also includes a hydraulic control system 59 with a first solenoid 60, a second solenoid 62, a third solenoid 64, a fourth solenoid 66, a fifth solenoid 68, and a sixth solenoid 70. In one embodiment the solenoids 60, 62, 64, 66, 68, and 70 are variable force solenoids. In the particular arrangement shown in FIG. 4, the first solenoid 60 is in selective fluid communication with the first clutch 26. The second solenoid 62 is in selective fluid communication with the second clutch 28. The third solenoid 64 is in selective fluid communication with the third clutch 30. The fourth solenoid 66 is in selective fluid communication with the fourth clutch 32. The fifth solenoid 68 is in selective fluid communication with the first brake 34. The sixth solenoid 70 is in selective fluid communication with the second brake 36. The locking mechanisms 72 and 74 can be any suitable mechanism that places the respective clutch or brake, such as, for example, those described below, in a ready state. The ready state refers to various states or conditions of the clutch or brake that may include a filled state where oil is fed to the circuits that actuate the clutch, a staged state where the clutch has been moved to near full engagement, and an engaged state where the clutch is fully engaged and ready to transmit torque, or any other state in between.

It should be appreciated that the hydraulic control system 59 may include various other systems, modules, solenoids, etc., without departing from the scope of the present invention. For example, in various arrangements, the hydraulic control system 59 includes variable bleed solenoids or on/off devices or any other suitable devices to selectively engage the torque transmitting mechanisms 26, 28, 30, 32, 34, and 36 by selectively communicating hydraulic fluid to the various torque transmitting mechanisms.

The solenoids 60, 62, 64, 66, 68, and 70 are provided pressurized hydraulic fluid by a pressure regulator subsystem that includes a pump 80 driven by an engine 79 and an accumulator 81. The accumulator 81 is controlled by an accumulator solenoid 82. Alternatively the transmission 10 may include a second, auxiliary pump 83. The pressure regulator subsystem including the pump 80 and accumulator 81, as well as the solenoids 60, 62, 64, 66, 68, and 70, receive instructions from a controller 90. The controller 90 may be a transmission control module (TCM), an engine control module (ECM), or a hybrid control module, any other type of controller, or any combination of controllers. The controller 90 is preferably an electronic control device having a preprogrammed digital computer or processor, control logic, memory used to store data, and at least one I/O peripheral. The control logic includes a plurality of logic routines for monitoring, manipulating, and generating data.

When the motor vehicle comes to a stop an auto stop event may occur where the engine 79 is automatically turned off. During the auto start when the engine 79 is turned back on and the motor vehicle begins to move, the motor vehicle typically starts again in first, second, or reverse gear. That is, the torque transmitting mechanisms 26, 32, 34, and 36 are engaged for reverse gear; torque transmitting mechanisms 26, 30, 34, and 36 are engaged for first gear; or torque transmitting mechanisms 26, 28, 34, and 36 are engaged for second gear. However, during the auto stop, the main pump 80 is no longer supplying pressure to the clutches and brakes. Accordingly, when the motor vehicle is ready to start again and the locking mechanisms 72 and 74 are not employed, the transmission pump 80 is generally required to pump sufficient pressure to the torque transmitting mechanisms 26, 30, and 34 and one of torque transmitting mechanisms 28, 30, and 32 depending on which gear has been commanded. Sufficient pressure is preferably provided so that the torque transmitting mechanisms can be quickly engaged without lag when the vehicle starts again. Alternatively, where an accumulator 81 is used, the accumulator 81 is sized to provide sufficient fluid volume and flow, as moderated by respective solenoids 60, 62, 64, 66, and 68 to the torque transmitting mechanisms 26, 30, and 34 and one of torque transmitting mechanisms 28, 30, and 32 depending on which gear has been commanded. The accumulator 81 provides the system pressure as the pump restarts and builds pressure. Alternatively, the auxiliary pump 83 can be employed in place of the accumulator 81 to provide the appropriate hydraulic fluid pressure to the devices in the hydraulic control system 59 to selectively engage the torque transmitting mechanisms 26, 30, 32, 34, and 36. In some arrangements a combination of the transmission pump 80, the accumulator 81, and the auxiliary pump 83 provides flow to the torque transmitting mechanisms.

With the implementation of the locking mechanisms 72 and 74, which can be mechanical latches or hydraulic latches or any other suitable mechanism and which can be under the control of the controller 90, the brakes 34 and 36 can be considered holding brakes. That is, prior to or at a start event, the locking mechanisms 72 and 74 are activated to ready the brakes 34 and 36, respectively. In the alternate embodiment, the locking mechanism 75 is activated to ready clutch 26. In still another embodiment, only one of the locking mechanisms 72, 74, and 75 is activated. As such, the transmission pump 80 or the accumulator 81 or the auxiliary pump 83 only has to provide sufficient pressure or sufficient volume of hydraulic fluid to engage two of the remaining torque transmitting mechanisms 26, 28, 30, and 32 for first, reverse, or second gear. Hence, with the use of the locking mechanisms 72, and 74, the transmission pump 80 or the accumulator 81 or the auxiliary pump 83 is required to provide pressure or fluid volume for two torque transmitting mechanisms for a start event, whereas without the locking mechanisms 72 and 74, the transmission pump 80 or the accumulator 81 or the auxiliary pump 83 is required to provide pressure or fluid volume for four torque transmitting mechanisms for a start event.

The locking mechanisms 72 and 74 are directly coupled to their respective brakes 34 and 36 and may be of various types. For example, locking mechanisms are described in, but are not limited to, U.S. Provisional Application No. 61/636,963, filed Apr. 23, 2012, and U.S. Provisional Application No. 61/640,944, filed May 1, 2012, the contents of which are incorporated herein by reference in their entirety.

The description of the invention is merely exemplary in nature and variations that do not depart from the gist of the invention are intended to be within the scope of the invention. Such variations are not to be regarded as a departure from the spirit and scope of the invention.

What is claimed is:

1. A transmission in a motor vehicle, the transmission comprising:
an input member;
an output member;
first, second, third and fourth planetary gear sets each having first, second and third members;
six torque transmitting mechanisms selectively engageable to interconnect one of the first, second, and third members with at least one other of the first members, second members, third members and a stationary member, wherein the torque transmitting mechanisms are selectively engageable in combinations of at least three to establish at least ten forward speed ratios and at least one reverse speed ratio between the input member and the output member; and
a first latching mechanism connected to a fifth of the six torque transmitting mechanisms, wherein the first latching mechanism latches the fifth torque transmitting mechanism in a ready state; and
a second latching mechanism connected to a sixth of the six torque transmitting mechanisms, wherein the second latching mechanism latches the sixth torque transmitting mechanism in the ready state, and
wherein the fifth and sixth torque transmitting mechanisms are in the ready state during a first forward gear or a second forward gear.

2. The transmission of claim 1 wherein the fifth and sixth torque transmitting mechanisms are in the ready state during a reverse gear.

3. The transmission of claim 1 wherein the first latching mechanism latches the fifth torque transmitting device in preparation for an engine stop event and the second latching mechanism latches the sixth torque transmitting device in preparation for an engine stop event.

4. The transmission of claim 1 wherein the first and second latching mechanisms are hydraulic latching mechanisms or mechanical latching mechanisms.

5. The transmission of claim 1 further comprising a third latching mechanism connected to a first of the six torque transmitting mechanisms, wherein the third latching mechanism latches the first torque transmitting mechanism in the ready state.

6. The transmission of claim 1 further comprising:
a first interconnecting member continuously interconnecting the third member of the first planetary gear set with the first member of the second planetary gear set;
a second interconnecting member continuously interconnecting the second member of the second planetary gear set with the third member of the third planetary gear set; and
a third interconnecting member continuously interconnecting the first member of the third planetary gear set with the third member of the fourth planetary gear set.

7. The transmission of claim 6 wherein a first of the six torque transmitting mechanisms is selectively engageable to interconnect the first member of the first planetary gear set with the first member of the fourth planetary gear set.

8. The transmission of claim 7 wherein a second of the six torque transmitting mechanisms is selectively engageable to interconnect the first member of the first planetary gear set with the second member of the fourth planetary gear set.

9. The transmission of claim 8 wherein a third of the six torque transmitting mechanisms is selectively engageable to interconnect the input member with at least one of the first member of the third planetary gear set and the third member of the fourth planetary gear set.

10. The transmission of claim 9 wherein a fourth of the six torque transmitting mechanisms is selectively engageable to interconnect at least one of the second member of the second planetary gear set and the third member of the third planetary gear set with the second member of the fourth planetary gear set.

11. The transmission of claim 10 wherein a fifth of the six torque transmitting mechanisms is selectively engageable to interconnect at least one of the third member of the first planetary gear set and the first member of the second planetary gear set with the stationary member.

12. The transmission of claim 11 wherein a sixth of the six torque transmitting mechanisms is selectively engageable to interconnect the third member of the second planetary gear set with the stationary member.

13. The transmission of claim 12 wherein the third member of the first planetary gear set and first member of the second, third and fourth planetary gear sets are sun gears, the second members of the first, second, third and fourth planetary gear sets are carrier members and the first member of the first planetary gear set and third member of the second, third and fourth planetary gear sets are ring gears.

14. The transmission of claim 1 wherein the input member is continuously interconnected with the second member of the first planetary gear set and wherein the output member is continuously interconnected with the second member of the third planetary gear set.

15. The transmission of claim 1 wherein two of the torque transmitting mechanisms are brakes and four of the torque transmitting mechanisms are clutches.

16. The transmission of claim 1 wherein the stationary member is a transmission housing.

17. A transmission comprising:
an input member;
an output member;
first, second, third and fourth planetary gear sets each having first, second and third members, wherein the input member is continuously interconnected with the second member of the first planetary gear set and wherein the output member is continuously interconnected with the second member of the third planetary gear set;
a first interconnecting member continuously interconnecting the third member of the first planetary gear set with the first member of the second planetary gear set;
a second interconnecting member continuously interconnecting the second member of the second planetary gear set with the third member of the third planetary gear set;
a third interconnecting member continuously interconnecting the first member of the third planetary gear set with the third member of the fourth planetary gear set;
a first torque transmitting mechanism selectively engageable to interconnect the first member of the first planetary gear set with the first member of the fourth planetary gear set;
a second torque transmitting mechanism selectively engageable to interconnect the first member of the first planetary gear set with the second member of the fourth planetary gear set;
a third torque transmitting mechanism selectively engageable to interconnect the input member with at least one of the first member of the third planetary gear set and the third member of the fourth planetary gear set;
a fourth torque transmitting mechanism selectively engageable to interconnect at least one of the second member of the second planetary gear set and the third member of the third planetary gear set with the second member of the fourth planetary gear set;
a fifth torque transmitting mechanism selectively engageable to interconnect at least one of the third member of the first planetary gear set and the first member of the second planetary gear set with the stationary member; and
a sixth torque transmitting mechanism selectively engageable to interconnect the third member of the second planetary gear set with the stationary member;
a first latching mechanism connected to the fifth torque transmitting mechanism, wherein the first latching mechanism latches the fifth torque transmitting mechanism in ready state; and
a second latching mechanism connected to the sixth torque transmitting mechanism, wherein the second latching mechanism latches the sixth torque transmitting mechanism in the ready state, and
wherein the fifth and sixth torque transmitting mechanisms are in the ready state during a first forward gear or a second forward gear.

18. The transmission of claim 17 wherein the fifth and sixth torque transmitting mechanisms are in the ready state during a reverse gear.

19. The transmission of claim 17 wherein the first latching mechanism latches the fifth torque transmitting device in preparation for an engine stop event of the motor vehicle and the second latching mechanism latches the sixth torque transmitting device in preparation for the engine stop event of the motor vehicle.

20. A transmission comprising:
an input member;
an output member;
first, second, third and fourth planetary gear sets each having sun gear, carrier member and ring gear, wherein the input member is continuously interconnected with the carrier member of the first planetary gear set and wherein the output member is continuously interconnected with the carrier member of the third planetary gear set;
a first interconnecting member continuously interconnecting the sun gear of the first planetary gear set with the sun gear of the second planetary gear set;
a second interconnecting member continuously interconnecting the carrier member of the second planetary gear set with the ring gear of the third planetary gear set;
a third interconnecting member continuously interconnecting the sun gear of the third planetary gear set with the ring gear of the fourth planetary gear set;
a first torque transmitting mechanism selectively engageable to interconnect the ring gear member of the first planetary gear set with the sun gear of the fourth planetary gear set;
a second torque transmitting mechanism selectively engageable to interconnect the ring gear of the first planetary gear set with the carrier member of the fourth planetary gear set;
a third torque transmitting mechanism selectively engageable to interconnect the input member with at least one of the sun gear of the third planetary gear set and the ring gear of the fourth planetary gear set;
a fourth torque transmitting mechanism selectively engageable to interconnect at least one of the carrier member of the second planetary gear set and the ring gear of the third planetary gear set with the carrier member of the fourth planetary gear set;
a fifth torque transmitting mechanism selectively engageable to interconnect at least one of the sun gear of the first planetary gear set and the sun gear member of the second planetary gear set with the stationary member;
a sixth torque transmitting mechanism selectively engageable to interconnect the ring gear of the second planetary gear set with the stationary member;
a first latching mechanism connected to the fifth torque transmitting mechanism, wherein the first latching mechanism latches the fifth torque transmitting mechanism in ready state; and
a second latching mechanism connected to the sixth torque transmitting mechanism, wherein the second latching mechanism latches the sixth torque transmitting mechanism in the ready state,
wherein the fifth and sixth torque transmitting mechanisms are in the engaged state during a first forward gear, and
wherein the torque transmitting mechanisms are selectively engageable in combinations of at least three to establish at least ten forward speed ratios and at least one reverse speed ratio between the input member and the output member.
